(19) United States
(12) Patent Application Publication
(10) Pub. No.: US 2011/0275026 A1
(43) Pub. Date: Nov. 10, 2011

(54) SYSTEMS AND METHODS FOR PROVIDING A DECORATIVE DENTAL TIP

(76) Inventor: Jason K. Smith, Cortez, CO (US)

(21) Appl. No.: 12/774,526

(22) Filed: May 5, 2010

(51) Int. Cl. A61C 19/00; B23P 17/04; G09B 19/00

(52) U.S. Cl. 433/90; 433/215; 29/428

(57) ABSTRACT

A decorative dental tip is provided for a dental syringe. The decorative dental tip includes a molded, outer surface portraying an object selected to alleviate an anxiety of a patient. The dental tip further includes a molded, inner lumen in fluid communication with a dental syringe.

### BACKGROUND OF THE INVENTION

1. Field of the Invention

The present invention relates to dental tips. In particular, the present invention relates to a decorative dental tip having a molded outer surface shaped to portray an object, such as an animal, a plant, a vehicle, and/or a cartoon character. At least some embodiments of the present invention further relate to methods for alleviating or reducing the anxiety of a patient, such as a child-patient. In particular, embodiments of the present invention relate to methods whereby a patient is given the option of choosing a decorative dental tip, the dental tip having a molded outer surface shaped to portray an object of interest to the patient, and a physician attaching the selected dental tip to a dental instrument thereby alleviating or reducing an anxiety of the patient related to the dental instrument.

2. Background and Related Art

Visits to the dentist's office can be a scary and anxiety provoking experience for many patients, particularly for child-patients. The fear and anxiety of being in a new environment, confronted by new faces and foreign instruments can stimulate a sympathetic nervous response in patients leading to such objective physical findings as increased heart rate, increased blood pressure, sweating, emotional liability, fidgeting, and reluctance to cooperate with the doctor's instructions. Most dentists and other doctors find it advantageous to try to relieve these fears and anxieties before and throughout a physical exam or procedure. This allows the child-patient to feel more at ease during the exam and cooperate with the examination and/or treatment procedures.

Some methods of alleviating a child-patient's anxieties include distracting the child by communicating with the child. Other methods of alleviating a child-patient's anxieties include distracting the child with a television monitor and a video presentation of child-patient's preference. Still further, some methods of distraction include administering an inhalation anesthetic, such as nitrous oxide, to the child-patient at a dosage that temporarily alleviates the patient's anxieties.

While each these methods have been shown to provide some benefits in reducing a patient's anxiety, none of these methods are directed towards reducing a patient's anxieties related to the instrumentation used by the dentist. Thus, while techniques currently exist that relate to alleviating the anxiety and/or nervousness of children patients, challenges still exist. Accordingly, it would be an improvement in the art to augment or even replace current techniques with other techniques.

### SUMMARY OF THE INVENTION

The present invention relates to decorative dental tips that are provided as a means of reducing the anxiety of a patient. In some implementations, a decorative dental tip is provided having a molded outer surface which portrays an object known to be visually appealing to the patient. A decorative dental tip may include a molded outer surface portraying an animal, a plant, a vehicle and/or a cartoon character. An interior lumen of the decorative dental tip is sized to receive an adapter portion of a dental syringe in a fluid-tight manner. The interior lumen further includes an opening whereby a fluid from the dental syringe is delivered to the patient via the decorative dental tip.

Implementations of the present invention further relate to methods for alleviating the anxiety of a patient. Some methods of the present invention includes steps whereby a patient selects a decorative dental tip, the doctor affixes the selected dental tip to the dental syringe, the dental syringe and tip are used for a dental procedure, and the dental tip is then removed from the dental syringe and given to the patient as a keepsake. A method of manufacture is further provided whereby a decorative dental tip is manufactured by first selecting an object that is visually appealing to a dental patient, followed by providing a dental tip having a molded outer surface that portrays the visually appealing object.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 is a perspective view of a conventional water/air dental syringe fitted with a conventional disposable tip;

FIG. 2 is a perspective view of a conventional water/air dental syringe fitted with a decorative tip in accordance with a representative embodiment of the present invention; and

FIG. 3 is a perspective view of a conventional water/air dental syringe fitted with a decorative tip, shown in cross-section, in accordance with a representative embodiment of the present invention.

### DETAILED DESCRIPTION OF THE INVENTION

Some embodiments of the present invention relate to a dental tip. In particular, some embodiments of the present invention relate to a decorative, disposable dental tip having a molded outer surface shaped to portray an object, such as an animal, a plant, a vehicle, and a cartoon character.

As used herein, the term “patient” generally refers to any dental patient and may specifically include a child-patient, an adolescent patient, an adult patient, and a patient prone to anxieties related to dentistry examinations and procedures.

As used herein, the terms “dental syringe” and “syringe” are used interchangeably to refer to a dental handpiece or instrument used to deliver water and/or air to the oral cavity of a patient, as well as remove or evacuate liquids and debris from the oral cavity.

As used herein, the term “fluid” generally refers to any substance capable of flowing and may specifically include water, air, compressed water, compressed air, and combinations thereof.

As used herein, the term “metallic” generally refers to any material comprising metal or metal alloys that are compatible with the practice of dentistry.

As used herein, the term “plastic” generally refers to any polymer material compatible with the practice of dentistry, and may include composites and composite fiber materials.

As used herein, the term “sterilizable” generally refers to any procedure whereby contaminants and pathogens are removed from a surface of an object, and may include procedures such as using an autoclave, boiling an object in water, and applying steam to the object.

As used herein, the terms “soothing color” and “soothing pattern” refer generally to colors and patterns known in the art to provide a psychological and/or physiological effect on the patient thereby reducing the anxiety of the patient.

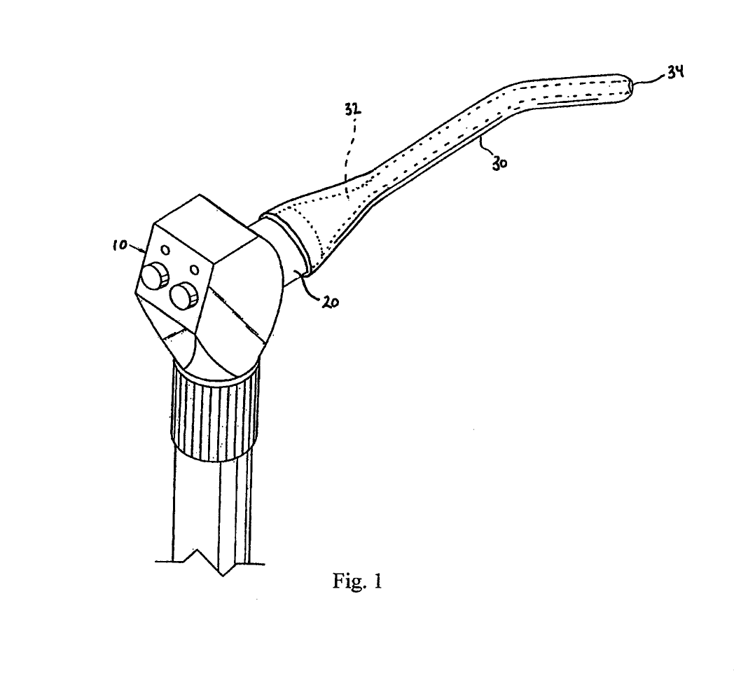

Referring now to FIG. 1, a conventional water/air syringe 10 is shown. Syringe 10 is commonly used by dentists to provide and evacuate liquids from the oral cavity during dental examinations and procedures. Syringe 10 is further used to provide compressed air, or a mixture of compressed air and compressed water to the patient's mouth. In some embodiments syringe 10 comprises an evacuator tip, such as a Yankauer suction tip, whereby a dentist removes liquids and debris from the oral cavity of a patient. An adapter 20 of syringe 10 generally provides a mounting surface whereby a disposable cover or tip 30 is temporarily fitted onto the syringe 10. An interior lumen 32 of tip 30, shown in phantom, is in fluid communication with syringe 10 such that water and air are easily provided to the patient from syringe 10 via an opening 34 provided in tip 30.

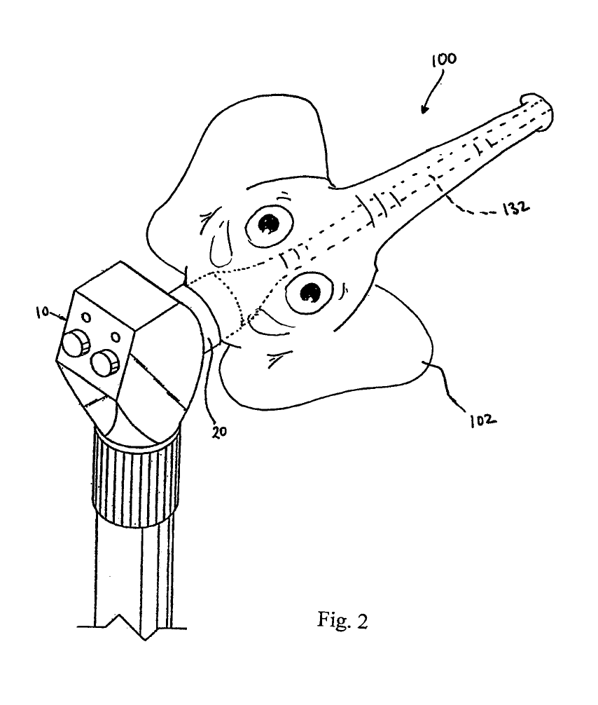

Referring now to FIG. 2, a decorative tip 100 in accordance with the teachings of the present invention is shown as coupled to syringe 10. Unlike convention tip 30, decorative tip 100 comprises a molded outer surface 102 having a shape configured to portray an animal, such as an elephant. The shape of outer surface 102 is generally selected to portray an item or object that is visually pleasing to a patient. For example, in some embodiments outer surface 102 is shaped to portray an animal, a plant, a vehicle and/or a cartoon character. In other embodiments, outer surface 102 is configured to further include a color or combination of colors that is visually pleasing to the patient. For example, in some embodiments outer surface 102 comprises a color known to provide a calming or soothing effect to the observer. In other embodiments, outer surface 102 comprises a plurality of colors to portray further the selected shape of outer surface 102. One having ordinary skill in the art will appreciate that subject matter portrayed by outer surface 102 is not limited to the examples provided herein, but rather may include any portrayal and/or color that is visually pleasing to a patient. Outer surface 102 may further include any portrayal and/or colors that serve to sooth or otherwise reduce the anxiety of the patient during the dental visit.

In some embodiments, decorative tip 100 comprises an injection molded plastic material, such as polypropylene or polyethylene. In other embodiments, decorative tip 100 comprises a metallic material, such as stainless steel. In the molding process, tip 100 is provided with an interior lumen 132 having a proximal end diameter configured to compatibly receive adapter 20 of syringe 10. In some embodiments, lumen 132 is configured to receive an elongate adapter (not shown) wherein the adapter extends then entire length of lumen 132. Thus, in some embodiments tip 100 comprises a sleeve to cover and protect a non-disposable tip (not shown) permanently or removable coupled to syringe 10. In this way, tip 100 prevents contamination of adapter 20 thereby extending the time required between sterilization procedures of syringe 10.

In some embodiments a mechanical connection between tip 100 and adapter 20 is achieved through at least one of a pressure fit, a friction fit, and a threaded fit. In other embodiments, a fluid-tight connection between tip 100 and adapter 20 is achieved. For example, in some embodiments tip 100 is coupled to adapter 20 via a luer connection. In some embodiments, decorative tip 100 is disposable, while in other embodiments decorative tip 100 is sterilizable and/or reusable.

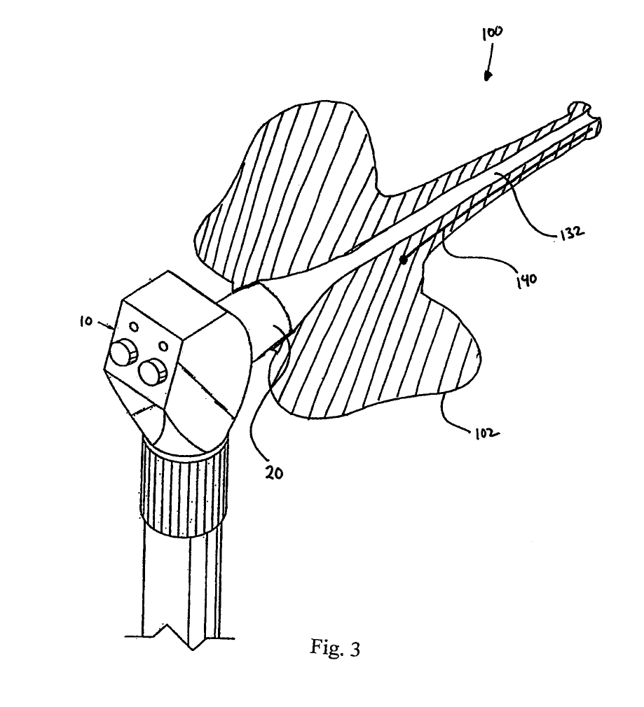

In some embodiments, decorative tip 100 comprises a rigid or semi-rigid material. In other embodiments, decorative tip 100 comprises a flexible or semi-flexible material that may be molded to conform to a desired shape or configuration. For example, in some embodiments tip 100 further comprises intermolded bendable members 140 that are plastically deformed by the user to achieve a desired shape or configuration for decorative tip 100, as shown in FIG. 3. In some embodiments, bendable member 140 comprises a metallic material, such as a metallic wire.

The present invention further relates to a method for alleviating or reducing the anxiety of a patient, such as a child-patient. In particular, the present invention relates to a method whereby a patient is given the option of choosing a decorative dental tip, the dental tip having a molded outer surface shaped to portray an object of interest to the patient, and a physician attaching the selected dental tip to a dental instrument thereby alleviating or reducing an anxiety of the patient related to the dental instrument.

In some embodiments of the present invention, a method for alleviating the anxiety of a patient is achieved by i) equipping syringe 10 with tip 100, wherein an outer surface of tip 100 is shaped to portray a subject that is visually pleasing to the patient. In other embodiments, a method for alleviating the anxiety of a patient is achieved through a series of steps whereby i) a patient is first offered an opportunity to select a desired tip, ii) the syringe 10 is equipped with the selected tip, and iii) the syringe 10 and desired tip are used for dental examination and/or procedures. Still further, in some embodiments a method for alleviating the anxiety of a patient is achieved through a series of steps whereby i) a patient is first offered an opportunity to select a desired tip, ii) the desired tip is then attached to the syringe 10, iii) the syringe 10 and desired tip are used for dental examination and/or procedures, and iv) the desired tip is removed from the syringe and given to the patient as a keepsake.

The present invention may be embodied in other specific forms without departing from its spirit or essential characteristics. For example, the present invention may be embodied in various other dental suction attachments. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A dental tip comprising a molded, decoratable outer surface portraying an object selected to alleviate an anxiety of a patient, the dental tip further comprising an interior lumen, whereby a fluid is delivered to or removed from a patient via the interior lumen of the dental tip.

2. The dental tip of claim 1, wherein the fluid comprises at least one of air, water, compressed air and compressed water.

3. The dental tip of claim 1, wherein the dental tip covers an adapter portion of the dental syringe.

4. The dental tip of claim 1, wherein the dental tip comprises a plastic material.

5. The dental tip of claim 1, wherein the dental tip comprises a metallic material.

6. The dental tip of claim 1, wherein the dental tip is disposable.

7. The dental tip of claim 1, wherein the dental tip is sterilizable.

8. The dental tip of claim 1, wherein the object comprises at least one of an animal, a plant, a vehicle, and a cartoon character.

9. The dental tip of claim 1, wherein the object comprises at least one of a soothing color and a soothing pattern.

10. The dental tip of claim 1, further comprising an intermolded bendable member.

11. A method for alleviating an anxiety of a patient, the method comprising:
selecting a decorative dental tip having a molded outer surface portraying an object visually appealing to a patient;
equipping a dental syringe with the selected decorative dental tip; and
performing dentistry on the patient with the dental syringe and the decorative dental tip.

12. The method of claim 11, further comprising:
removing the decorative dental tip from the dental syringe; and
giving the decorative dental tip to the patient as a keepsake.

13. The method of claim 11, wherein the object comprises at least one of an animal, a plant, a vehicle, and a cartoon character.

14. The method of claim 11, wherein the object comprises at least one of a soothing color and a soothing pattern.

15. The method of claim 11, further comprising disposing the decorative dental tip following a dental procedure.

16. The method of claim 11, further comprising providing the patient with a selection of the decorative dental tip from a plurality of decorative dental tips.

17. A method for manufacturing a decorative dental tip for alleviating an anxiety of a patient, the method comprising:
selecting an object that is visually appealing to a dental patient; and
providing a dental tip having a molded outer surface that portrays the object.

18. The method of claim 17, wherein the object comprises at least one of an animal, a plant, a vehicle, and a cartoon character.

19. The method of claim 17, wherein the object comprises at least one of a soothing color and a soothing pattern.

20. The method of claim 17, wherein the decorative dental tip is disposable.
